(19) United States
(12) Patent Application Publication
(10) Pub. No.: US 2004/0058097 A1
(43) Pub. Date: Mar. 25, 2004

(54) Curled or crimped decorative grass having an optical effect

(76) Inventor: Donald E. Weder, Highland, IL (US)

Correspondence Address: DUNLAP, CODDING & ROGERS P.C., PO BOX 16370, OKLAHOMA CITY, OK, 73113, US

(21) Appl. No.: 10/667,826

(22) Filed: Sep. 22, 2003

Related U.S. Application Data
(63) Continuation of application No. 09/630,644, filed on Aug. 1, 2000, now abandoned.
Application No. 09/630,644 is a continuation-in-part of application No. 09/330,742, filed on Jun. 11, 1999, now abandoned.

(51) Int. Cl. B32B 1/00; B32B 31/04; B32B 31/18; B44F 1/14

(52) U.S. Cl. 428/17; 428/174; 156/163; 428/181; 156/222

(57) ABSTRACT

Methods for forming decorative grass possessing a unique optical effect from a sheet of laminated optical effect material. The decorative grass has a curl or a crimp set therein to enhance the light-reflecting characteristics of the decorative grass and to provide greater volume of the decorative grass for a given weight of decorative grass.

### CROSS REFERENCE TO RELATED APPLICATIONS

This application is a continuation of U.S. Ser. No. 09/630,644, filed Aug. 1, 2000; which is a continuation-in-part of U.S. Ser. No. 09/330,742, filed Jun. 11, 1999, now abandoned; the contents of each of which are hereby expressly incorporated herein by reference in their entirety.

### STATEMENT REGARDING FEDERALLY SPONSORED RESEARCH OR DEVELOPMENT

Not applicable.

### FIELD OF THE INVENTION

The present invention relates to methods of forming decorative elements such as decorative grass and glitter. More particularly, the present invention relates to methods of forming decorative grass having an optical effect and having curls or crimps formed therein.

### BRIEF DESCRIPTION OF THE DRAWINGS

FIG. 1 is a perspective view of a curled sheet of laminated optical effect material constructed in accordance with the present invention.

FIG. 2 is a perspective view of a first sheet of material and a second sheet of material from which the curled sheet of laminated optical effect material of FIG. 1 is constructed, the first sheet of material being shorter in length than the second sheet of material.

FIG. 3 is a perspective view of the sheets of material of FIG. 2 showing the first sheet of material in a stretched position wherein the length of the first sheet of material is substantially equal to the length of the second sheet of material.

FIG. 4 is a perspective view of a flat sheet of laminated optical effect material constructed in accordance with the present invention.

FIG. 5 is a perspective view of a first sheet of material and a second sheet of material from which the flat sheet of laminated optical effect material of FIG. 4 is constructed.

FIG. 6 is a side elevational view of a curl forming device in a retracted position.

FIG. 7 is a side elevational view of the curl forming device of FIG. 6 showing the flat sheet of laminated optical effect material of FIG. 4 disposed therein, and the curl forming device in an extended position.

FIG. 8 is a perspective view of a curled sheet of laminated optical effect material formed from the sheet of laminated optical effect material of FIG. 4.

FIG. 9 is a side elevational view of a crimp forming device in a retracted position.

FIG. 10 is a side elevational view of the crimp forming device of FIG. 9 having the flat sheet of laminated optical effect material of FIG. 4 disposed therein, and the crimp forming device being in an extended position.

FIG. 11 is a perspective view of a crimped sheet of laminated optical effect material formed from the sheet of laminated optical effect material of FIG. 4.

FIG. 12 is a perspective view of a curled sheet of laminated optical effect material constructed in accordance with the present invention disposed on a cutting apparatus.

FIG. 13 is a perspective view of the curled sheet of laminated optical effect material and cutting apparatus of FIG. 12 showing a cutting element of the cutting apparatus in an extended position whereby a piece of curled decorative grass having an optical effect is cut from the curled sheet of laminated optical effect material.

FIG. 14 is a perspective view of a curled sheet of laminated optical effect material disposed on a modified cutting apparatus.

FIG. 15 is a perspective view of the curled sheet of laminated optical effect material and modified cutting apparatus of FIG. 14 showing a cutting element of the modified cutting apparatus in an extended position whereby several pieces of curled glitter are cut from the curled sheet of laminated optical effect material.

### BACKGROUND OF THE INVENTION

Decorative elements, such as decorative grass and glitter, are frequently used to decorate a variety of items. For example, decorative grass is used in virtually all Easter baskets to enhance the visual aesthetics of the baskets by providing color and glimmering qualities to the arrangement. Glitter may be added to a multitude of items such as clothing or paper to provide a sparkling, light-reflecting aspect to the item.

Decorative grass and glitter are typically formed by cutting specific shapes from sheets or webs of material. In the case of decorative grass, these shapes are usually long, thin filaments of the sheets or webs of material. Regarding glitter, the shapes are typically very small squares or rectangles, though the shapes may sometimes be circles, stars or other geometric or abstract shapes. As used herein, the term “glitter” also refers to materials commonly known as confetti, sequins and flakes.

Polymeric film is a material commonly used in producing such decorative elements. As used herein, the term “polymeric film” refers to any synthetic polymeric film such as a polypropylene film, polyethylene film or polyvinyl chloride film, or a naturally occurring polymer such as cellophane. A polymeric film, as contemplated and described in detail hereinafter, is relatively strong and not as subject to tearing as might be the case with paper or foil. Other materials which may be used to produce decorative elements include paper, metallized film, or any combination of polymeric film, paper or metallized film.

One of the most desirable features of decorative grass and glitter is a light-reflecting characteristic. Therefore, it is highly desirable to produce such decorative elements in a manner that maximizes the light-reflecting properties of the decorative elements.

Additionally, since these items are frequently sold by volume, a method of manufacturing decorative elements which increases the volume of the packaged decorative elements without adding mass or weight is desirable in that such a method would make manufacturing a given volume of decorative elements less expensive. Similarly, the packaged decorative elements produced by such a method would appear to contain a greater amount than the same weight of a competing product, thereby resulting in higher sales for the manufacturer.

Methods of manufacturing decorative elements which enhance their light-reflecting qualities are known in the art. One of these methods is described and claimed in U.S. Pat. No. 5,576,089 entitled “Optical Effect Material and Methods” issued to Weder on Nov. 19, 1996, the Specification of which is expressly incorporated herein by reference. The referenced method involves combining three sheets of material having different optical qualities to form one sheet of material having unique optical qualities. However, the method disclosed in the referenced patent does not recognize or envision producing decorative elements having such unique optical characteristics while at the same time increasing the volume of such elements without adding weight.

Conversely, methods of producing decorative elements which add volume without adding weight to the packaged product are known in the art. However, these methods do not recognize or envision producing such decorative elements with increased volume from a unique optical effect material having properties as described above for the optical effect material of U.S. Pat. No. 5,576,089. These methods typically form the sheets of material from which the decorative elements are produced by extrusion of a polymeric material. The resulting sheet of material is stretched while heated, and the stretched sheet of material is then cut into decorative elements (such as decorative grass) having a curl. This curl of the decorative elements allows a given weight of packaged product to appear “fluffed”, that is, such decorative elements have a greater volume than a similar weight of decorative elements formed without a curl. Such a method is described and claimed in U.S. Pat. No. 4,292,266 entitled “Process For Making Decorative Grass” issued to Weder et al on Sep. 29, 1981, the Specification of which is expressly incorporated by reference herein. Unfortunately, this method cannot be used with an optical effect material having characteristics as described above for the optical effect material of U.S. Pat. No. 5,576,089.

The present invention contemplates a method for producing decorative elements such as decorative grass and glitter from optical effect material wherein the decorative elements appear to have an increased volume without increasing the weight of the product. The method involves combining two separate sheets of material to form one sheet of laminated optical effect material having a curl or a crimp therein. The sheet of laminated optical effect material is then cut to produce decorative elements having the aforementioned desired qualities.

### DETAILED DESCRIPTION OF THE INVENTION

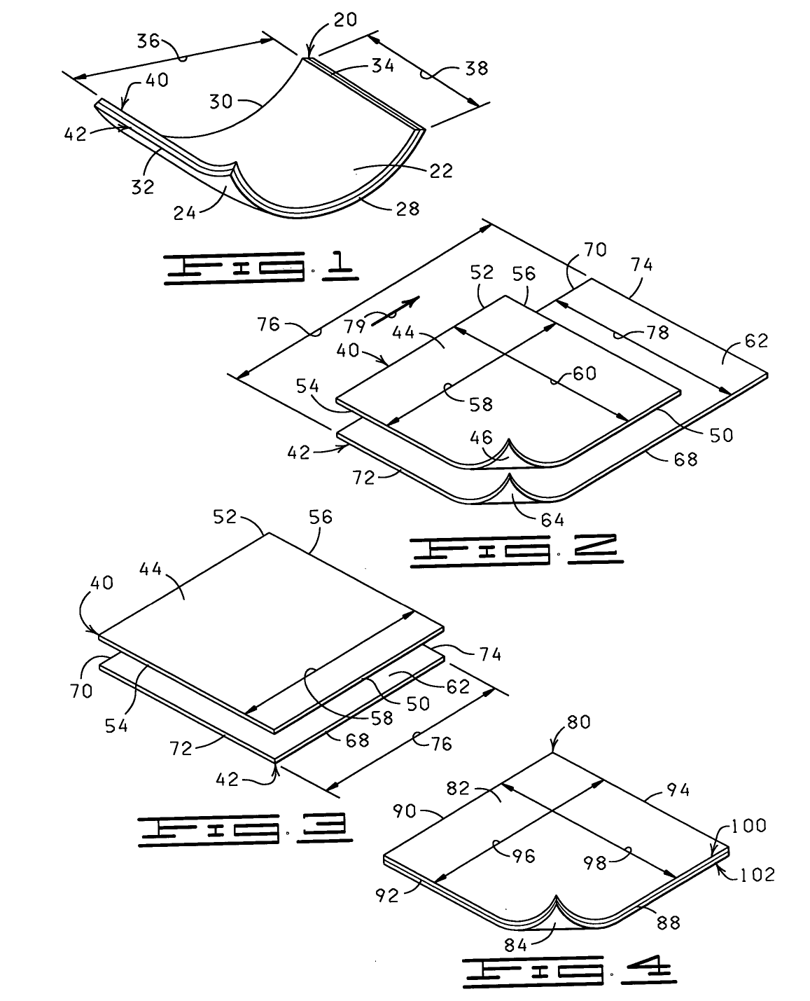

### Description of FIGS. 1-3

Shown in FIG. 1 and designated therein by the reference numeral 20 is a sheet of laminated optical effect material having a distortion set therein. The distortion is illustrated as being a curl; however, it should be understood that the distortion may also be at least one crimp, as will be described in more detail hereinafter. The curled sheet of laminated optical effect material 20 has a first surface 22, a second surface 24, a first side 28, a second side 30, a first end 32 and a second end 34. The sheet of optical effect material 20 has a length 36 and a width 38, the length 36 being the distance between the first and second ends 32 and 34 of the sheet of optical effect material 20, and the width 38 being the distance between the first and second sides 28 and 30 of the curled sheet of laminated optical effect material 20.

The curled sheet of laminated optical effect material 20 comprises a first sheet of material 40 and a second sheet of material 42. As shown in FIG. 2, the first sheet of material 40 has a first surface 44, a second surface 46, a first side 50, a second side 52, a first end 54 and a second end 56. The first sheet of material 40 has a length 58 and a width 60, the length 58 being the distance between the first and second ends 54 and 56 of the first sheet of material 40, and the width 60 being the distance between the first and second sides 50 and 52 of the first sheet of material 40.

Similarly, the second sheet of material 42 has a first surface 62, a second surface 64, a first side 68, a second side 70, a first end 72 and a second end 74. The second sheet of material 42 has a length 76 and a width 78, the length 76 being the distance between the first and second ends 72 and 74 of the second sheet of material 42, and the width 78 being the distance between the first and second sides 68 and 70 of the second sheet of material 42.

The first sheet of material 40 is constructed from any suitable material that is capable of transmitting light to the second sheet of material 42 when the first sheet of material 40 is laminated to the second sheet of material 42 to form the sheet of laminated optical effect material 20. Additionally, the first sheet of material 40 must be capable of transmitting light reflected from the second sheet of material 42. Further, the first sheet of material 40 must be suitable for making decorative elements such as decorative grass and glitter.

The thickness of the first sheet of material 40 can vary widely, as long as the sheet of laminated optical effect material 20 constructed therefrom functions in accordance with the present invention. Generally, the first sheet of material 40 has a thickness in a range of from about 0.1 mil to about 10 mil. Preferably, the first sheet of material 40 has a thickness in a range of from about 0.4 mil to about 0.9 mil. The first sheet of material 40 may be constructed of a single layer of material or a plurality of layers of the same or different types of materials. When the first sheet of material 40 is constructed of a plurality of layers of material, the layers of material may be laminated together by any method known in the art.

While any suitable material having the above-described properties can be employed as the first sheet of material 40 of the sheet of laminated optical effect material 20, desirable results can be obtained wherein the first sheet of material 40 comprises a polymeric film such as Vifan BT medium slip biaxially oriented polypropylene film (clear) having a thickness in a range of from about 0.4 mil to about 0.9 mil, available from Vifan Canada, Inc., Vifan Street, Lanoraie d'Autray, Quebec, Canad JOK 1EO.

Although the first sheet of material 40 is depicted in FIGS. 1-3 as being square to rectangular in shape, it is to be understood that the first sheet of material 40 can be provided with any shape or configuration that is suitable for the purposes described herein. For example, the first sheet of material 40 may be square, rectangular, circular, or any other geometric, non-geometric or abstract shape.

The second sheet of material 42 is constructed from any suitable material that is substantially iridescent, i.e., the material demonstrates shifting changes in color or an interplay of rainbow-like colors when viewed from different angles. In addition, the second sheet of material 42 must be suitable for making decorative elements such as decorative grass and glitter. The second sheet of material 42 may be constructed from polymeric film, metal, paper, or any combination thereof.

The thickness of the second sheet of material 42 can vary widely as long as the sheet of laminated optical effect material 20 constructed therefrom functions in accordance with the present invention. Generally, the second sheet of material 42 has a thickness in a range of from about 0.1 mil to about 10 mil. Preferably, the second sheet of material 42 has a thickness in a range of from about 0.4 mil to about 0.9 mil. The second sheet of material 42 may be constructed of a single layer of material or a plurality of layers of the same or different types of materials. When the second sheet of material 42 is constructed of a plurality of layers of material, the layers of material may be laminated together by any method known in the art.

While any suitable material having the above-described properties can be employed as the second sheet of material 42 of the sheet of laminated optical effect material 20, desirable results can be obtained when the second sheet of material 42 is an iridescent film manufactured by Mearl Corporation, 1050 Lower South Street, Peekskill, N.Y., 10566, under the trademark IF-8531 R/S, having a thickness in a range of from about 0.4 mil to about 0.9 mil.

Although the second sheet of material 42 shown in FIGS. 1-3 is rectangular in shape, the second sheet of material 42 can be provided with any shape or configuration that is suitable for the purposes described herein. For example, the second sheet of material 42 may be square, rectangular, circular, or any other geometric, non-geometric or abstract shape. However, it is desirable that the second sheet of material 42 have substantially the same shape as the first sheet of material 42.

As will be explained in greater detail hereinafter, the preferred method for providing a curled sheet of laminated optical effect material 20 in accordance with the present invention requires that one of the first or second sheets of material 40 or 42 be of smaller size than the other. It is desirable that only one dimension of the first or second sheet of material 40 or 42 is smaller than the corresponding dimension of the other sheet of material 40 or 42.

As depicted in FIG. 2, the first sheet of material 40 is sized smaller than the second sheet of material 42. In particular, the length 58 of the first sheet of material 40 is shorter than the length 76 of the second sheet of material 42. However, it should be understood that, if desired, the width 60 of the first sheet of material 40 could be of a different dimension than the width 78 of the second sheet of material 42. Alternatively, both the length 58 and the width 60 of the first sheet of material 40 could be of different measure than the length 76 and the width 78 of the second sheet of material 42.

As shown in FIG. 2, the first sheet of material 40 is disposed adjacent the second sheet of material 42 so that the second surface 46 of the first sheet of material 40 is disposed adjacent the first surface 62 of the second sheet of material 42. The first end 54 of the first sheet of material 40 is aligned with the first end 72 of the second sheet of material 42. The first and second sides 50 and 52 and the second end 56 of the first sheet of material 40 are aligned, respectively, with the first and second sides 68 and 70 and the second end 74 of the second sheet of material 42.

The first sheet of material 40 is then stretched in the direction indicated by an arrow 79 (FIG. 2) until the length 58 of the first sheet of material 40 is approximately equal to the length 76 of the second sheet of material 42, substantially as shown in FIG. 3. In the stretched condition of the first sheet of material 40, the size of the first sheet of material 40 should approximate the size of the second sheet of material 42, and the first and second sides 28 and 30 and first and second ends 32 and 34 of the first sheet of material 40 should be substantially aligned, respectively, with the first and second sides 50 and 52 and first and second ends 54 and 56 of the second sheet of material 42.

With the first sheet of material 40 in the stretched condition so that the first and second sheets of material 40 and 42 are in substantial alignment, the second surface 46 of the first sheet of material 40 is brought into contact with the first surface 62 of the second sheet of material 42. The first and second sheets of material 40 and 42 are then laminated together by any method known in the art. By laminating the first sheet of material 40 to the second sheet of material 42 while the first sheet of material 40 is in the stretched condition, the first sheet of material 40 creates a recoil tension wherein the length 58 of the first sheet of material 40 tends to return to its original dimension. This action causes the curled laminated sheet of optical effect material 20 produced by laminating the first and second sheets of material 40 and 42 to curl in the direction of the first sheet of material 40 substantially as shown in FIG. 1.

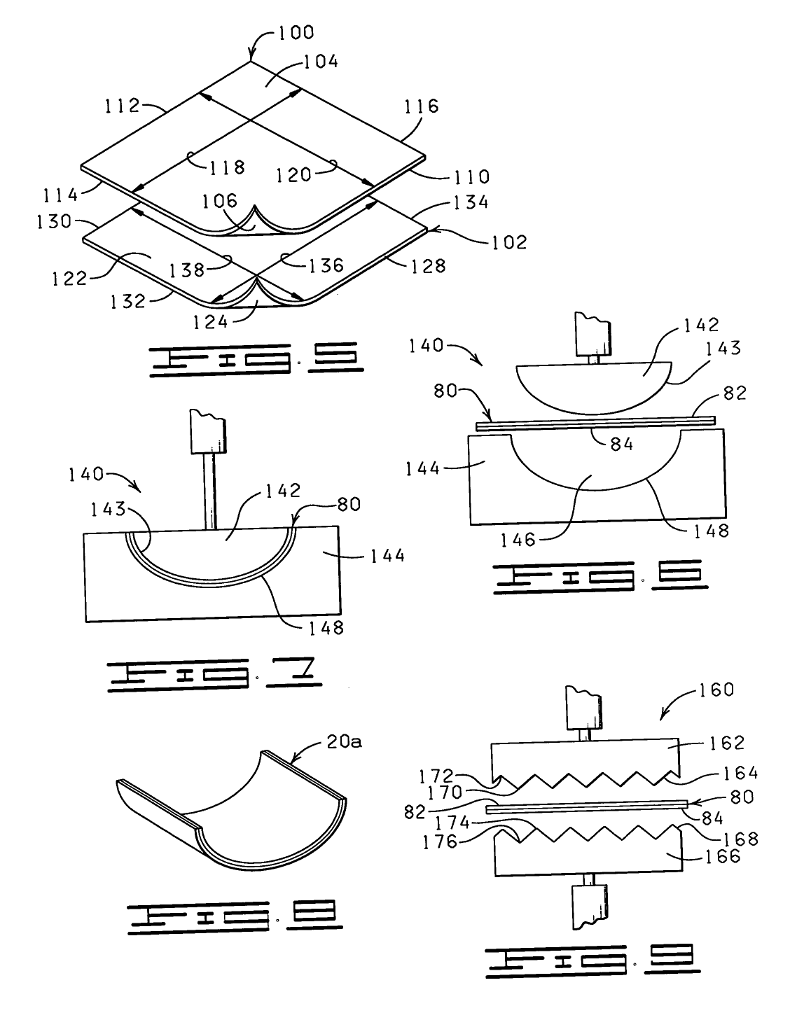

### Description of FIGS. 4-11

Depicted in FIGS. 4-11 is an alternate method of providing a sheet of laminated optical effect material having a distortion set therein. Shown in FIG. 4 and designated therein by the reference numeral 80 is a flat sheet of laminated optical effect material. FIGS. 5-8 illustrate a method of setting a curl in the flat sheet of laminated optical effect material 80 of FIG. 4, while FIGS. 9-11 illustrate a method of forming a crimp in the flat sheet of laminated optical effect material 80 of FIG. 4.

Referring more specifically to FIG. 4, the sheet of laminated optical effect material 80 is similar to the sheet of laminated optical effect material 20 described herein before with reference to FIG. 1, except that the sheet of laminated optical effect material 80 does not have a distortion set therein. The sheet of laminated optical effect material 80 has a first surface 82, a second surface 84, a first side 88, a second side 90, a first end 92 and a second end 94. The sheet of laminated optical effect material 80 has a length 96 and a width 98, the length 96 being the distance between the first and second ends 92 and 94 of the sheet of laminated optical effect material 80, and the width 98 being the distance between the first and second sides 88 and 90 of the sheet of laminated optical effect material 80.

The sheet of laminated optical effect material 80 comprises a first sheet of material 100 and a second sheet of material 102. As illustrated in FIG. 5, the first sheet of material 100 has a first surface 104, a second surface 106, a first side 110, a second side 112, a first end 114 and a second end 116. The first sheet of material 100 has a length 118 and a width 120, the length 118 being the distance between the first and second ends 114 and 116 of the first sheet of material 100, and the width 120 being the distance between the first and second sides 110 and 112 of the first sheet of material 100. The first sheet of material 100 is constructed from the same materials and in the same manner as the first sheet of material 40 described hereinbefore with reference to FIGS. 1-3.

Similarly, the second sheet of material 102 has a first surface 122, a second surface 124, a first side 128, a second side 130, a first end 132 and a second end 134. The second sheet of material 102 has a length 136 and a width 138, the length 136 being the distance between the first and second ends 132 and 134 of the second sheet of material 102, and the width 138 being the distance between the first and second sides 128 and 130 of the second sheet of material 102. The second sheet of material 102 is constructed from the same materials and in the same manner as the second sheet of material 42 described hereinbefore with reference to FIGS. 1-3.

As shown in FIG. 5, the first sheet of material 100 and the second sheet of material 102 are sized to be of similar dimensions. That is, the lengths 118 and 136 of the first and second sheets of material 100 and 102, respectively, are approximately equal, and the widths 120 and 138 of the first and second sheets of material 100 and 102, respectively, are approximately equal. The first and second sides 110 and 112 and first and second ends 114 and 116 of the first sheet of material 100 are aligned, respectively, with the first and second sides 128 and 130 and the first and second ends 132 and 134 of the second sheet of material 102. The second surface 106 of the first sheet of material 100 is disposed adjacent the first surface 122 of the second sheet of material 102 and then brought into contact with the first surface 122 of the second sheet of material 102. The first and second sheets of material 100 and 102 are then laminated by any method known in the art.

The resulting sheet of laminated optical effect material 80 (FIG. 4) is substantially flat since neither the first sheet of material 100 nor the second sheet of material 102 was stretched before lamination. At this point, a distortion, such as a curl or crimp, may be set in the sheet of laminated optical effect material 80 by contacting one of the first or second surfaces 82 or 84 of the sheet of laminated optical effect material 80 with a surface capable of providing a curl or a crimp in the sheet of laminated optical effect material 80.

Shown in FIGS. 6 and 7 and designated therein by the reference numeral 140 is a curl forming device for providing a curl in the sheet of laminated optical effect material 80. The curl forming device 140 comprises a first or male die portion 142 having a convex surface 143 and a second or female die portion 144 having a cavity 146 with a concave surface 148. The first die portion 142 fits within the cavity 146 of the second die portion 144 and is selectively movable between a retracted position as shown in FIG. 6, wherein the first die portion 142 and the second die portion 144 are spatially separated, and an extended position as shown in FIG. 7, wherein the first die portion 142 is disposed within the cavity 146 of the second die portion 144.

The sheet of laminated optical effect material 80 is placed between the first die portion 142 and the second die portion 144 of the curl forming device 140 when the first die portion 142 is in the retracted position substantially as shown in FIG. 6. When the first die portion 142 is thereafter moved to the extended position, the convex surface 143 of the first die portion 142 comes into contact with either the first or the second surface 82 or 84 of the sheet of laminated optical effect material 80, depending on whether the first surface 82 or the second surface 84 of the sheet of laminated optical effect material 80 is facing the first die portion 142 when the sheet of laminated optical effect material 80 is placed between the first die portion 142 and the second die portion 144 of the die 140.

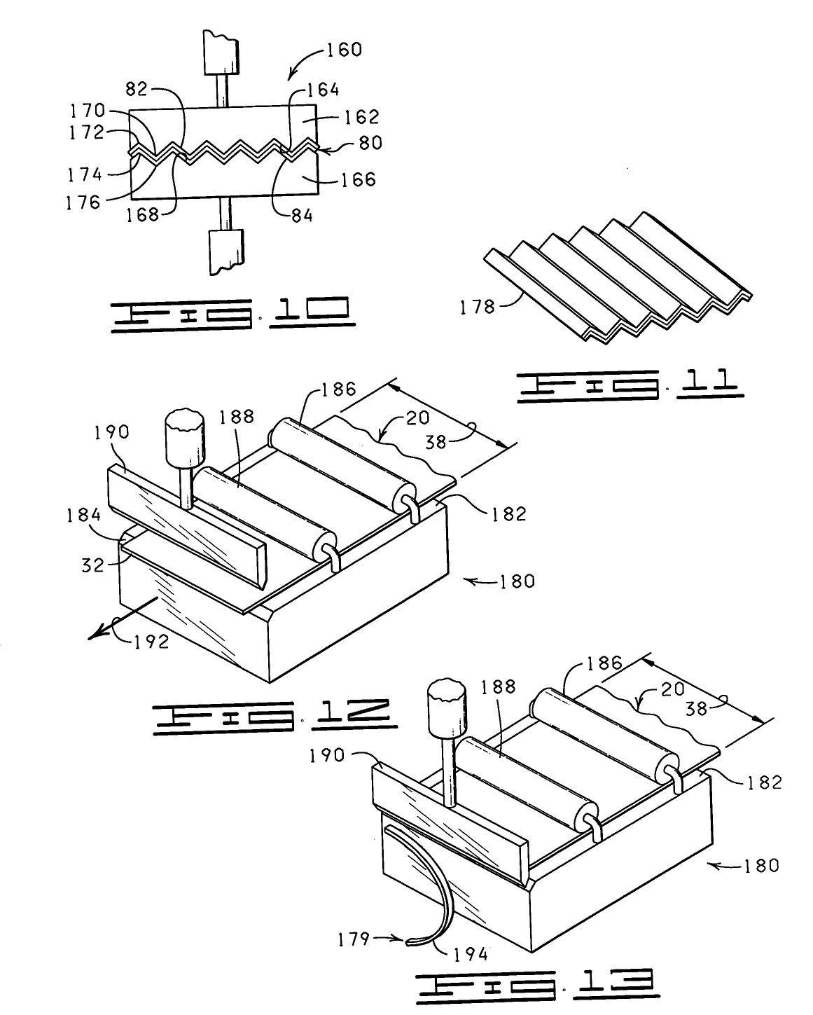

As the first die portion 142 of the curl forming device 140 continues to extend, the sheet of laminated optical effect material 80 is distorted, or curled, to conform to the shape of the convex surface 143 of the first die portion 142. Sufficient pressure is applied to the sheet of laminated optical effect material 80 so that, when the first die portion 142 is moved to the retracted position, the sheet of laminated optical effect material 80 retains the curl after it has been removed from the curl forming device 140. This provides a curled sheet of laminated optical effect material 20a as shown in FIG. 8.

Although the method shown in FIGS. 6-8 contemplates using a curl forming device 140 to curl the sheet of laminated optical effect material 80, any method known in the art may be used to accomplish the same result. For example, the first or second surface 82 or 84 of the sheet of laminated optical effect material 80 may be contacted, under pressure, with a curled surface (not shown) such as an edge or a roller capable of producing a curl in the sheet of laminated optical effect material 80. That is, the sheet of laminated optical effect material 80 is rolled, under pressure, until the first or second surface 82 or 84 has been contacted by the curled surface and a curl is produced in the sheet of laminated optical effect material 80.

It may be desired that the sheet of laminated optical effect material 80 have one or more crimps set therein rather than a curl as previously shown. FIGS. 9-11 show how a crimp, or a plurality of crimps, may be set in the sheet of laminated optical effect material 80. After the sheet of laminated optical effect material 80 has been formed by the method described hereinbefore with reference to FIGS. 4 and 5, the sheet of laminated optical effect material 80 may be introduced into a crimp forming device 160 (FIGS. 9 and 10).

The crimp forming device 160 comprises a first die portion 162 having a first crimp forming surface 164 and a second die portion 166 having a second crimp forming surface 168. The first crimp forming surface 164 of the first die portion 162 of the crimp forming device 160 comprises a plurality of first ridges, only one of which is designated by the reference numeral 170, and a plurality of first troughs, only one of which is designated by the reference numeral 172. The first ridges 170 and the first troughs 172 are alternately formed along the first crimp forming surface 164 of the first die portion 162. That is, each first ridge 170 is formed between two first troughs 172, and each first trough 172 is formed between two first ridges 170.

The second crimp forming surface 168 of the second die portion 166 of the crimp forming device 160 comprises a plurality of second ridges, only one of which is designated by the reference numeral 174, and a plurality of second troughs, only one of which is designated by the reference numeral 176. The second ridges 174 and the second troughs 176 are alternately formed along the second crimp forming surface 168 of the second die portion 166. That is, each second ridge 174 is formed between two second troughs 176, and each second trough 176 is formed between two second ridges 174.

The first die portion 162 of the crimp forming device 160 is selectively movable between a retracted position, as shown in FIG. 9, and an extended position, as shown in FIG. 10. In the retracted position, the first die portion 162 is spatially separated from the second die portion 166. In the extended position, the first crimp forming surface 164 of the first die portion 162 engages the first or the second surface 82 or 84 of the sheet of laminated optical effect material 80 (depending on the orientation of the sheet of laminated optical effect material 80 in the crimp forming device 160), and the second crimp forming surface 168 of the second die portion 166 engages the opposite surface 82 or 84 of the sheet of laminated optical effect material 80. The first ridges 170 and the first troughs 172 of the first crimp forming surface 164 of the first die portion 162, and the second ridges 174 and the second troughs 176 of the second crimp forming surface 168 of the second die portion 166 are disposed such that, when the first die portion 162 is moved to the extended position, the first ridges 170 of the first crimp forming surface 164 of the first die portion 162 are disposed within the second troughs 176 of the second crimp forming surface 168 of the second die portion 166, and the second ridges 174 of the second crimp forming surface 168 of the second die portion 166 are disposed within the first troughs 172 of the first crimp forming surface 164 of the first die portion 162 of the crimp forming device 160.

In operation, the first die portion 162 is disposed in the retracted position substantially as shown in FIG. 9, and the sheet of laminated optical effect material 80 is placed between the first die portion 162 and the second die portion 166 of the crimp forming device 160. The first die portion 162 is thereafter moved to the extended position as shown in FIG. 10, where the first crimp forming surface 164 of the first die portion 162 comes into contact with either the first or the second surface 82 or 84 of the sheet of laminated optical effect material 80, depending on whether the first surface 82 or the second surface 84 of the sheet of laminated optical effect material 80 is facing the first die portion 162 when the sheet of laminated optical effect material 80 is placed between the first die portion 162 and the second die portion 166.

As the first die portion 162 of the crimp forming device 160 continues to extend, the sheet of laminated optical effect material 80 conforms to the shape of the first crimp forming surface 164 of the first die portion 162 and the second crimp forming surface 168 of the second die portion 166 of the crimp forming device 160, thereby forming at least one crimp in the sheet of laminated optical effect material 80. Sufficient pressure is applied to the sheet of laminated optical effect material 80 so that, when the first die portion 162 of the crimp forming device 160 is moved to the retracted position, the sheet of laminated optical effect material 80 retains the crimps after it has been removed from the crimp forming device 160. This provides the crimped sheet of laminated optical effect material 178 shown in FIG. 11.

Although the method shown contemplates using a crimp forming device 160 to crimp the sheet of laminated optical effect material 80, any method known in the art may be used to accomplish the same result. Additionally, it may be desirous to set only one crimp in the sheet of laminated optical effect material 80 before cutting only a portion of the sheet of laminated optical effect material 80 as described hereinafter.

After a curled or crimped sheet of laminated optical effect material 20, 20a or 178 having a curl or crimps set therein has been provided, it may then be cut to form decorative elements such as decorative grass or glitter.

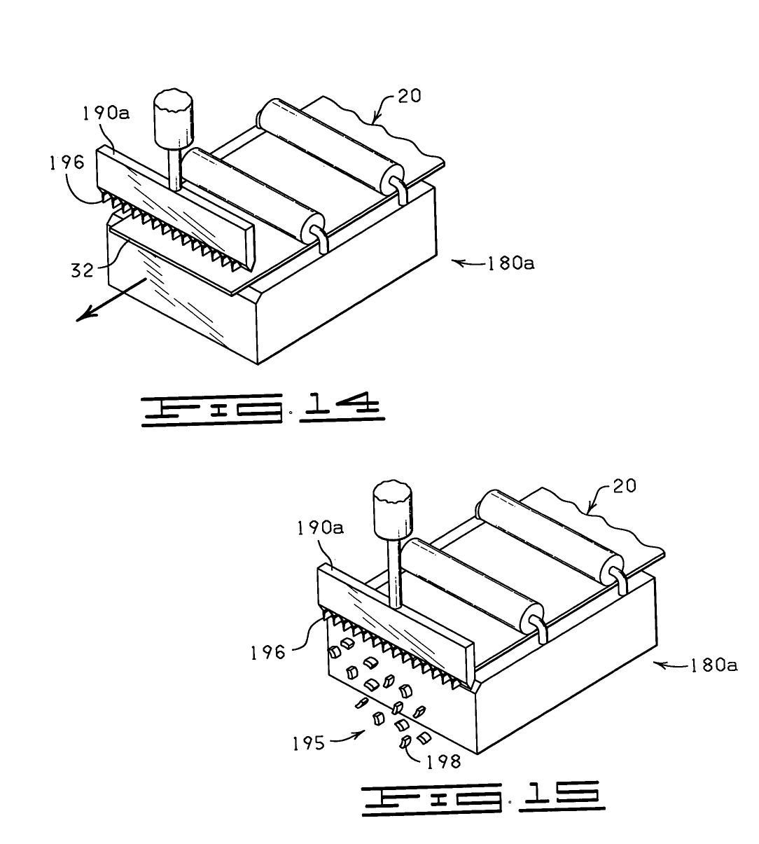

Shown in FIGS. 12 and 13 is one method for cutting a curled laminated optical effect material 20 to form curled optical effect decorative grass 179. Although only one method is shown, any known method by which a curled laminated optical effect material 20 may be cut to form decorative grass 179 may be utilized without departing from the spirit and scope of the present invention. It should be noted that, although the method shown in FIGS. 12 and 13 depicts a curled laminated optical effect material 20 being cut to form decorative grass having an optical effect, the method may also be used to cut the crimped laminated optical effect material 178 (FIG. 11) to form decorative grass 179 having an optical effect.

FIG. 12 shows a schematic representation of a cutting apparatus 180 which may be used to cut a curled laminated optical effect material 20 to form curled optical effect decorative grass 179. The curled sheet of laminated optical effect material 20 is depicted as being in the form of a roll, only a portion of which is shown in FIGS. 12-13. The cutting apparatus 180, which has a substantially flat upper support surface 182, comprises a bevel 184, a first roller 186, a second roller 188 and a cutting element 190. The curled laminated optical effect material 20 is disposed on the substantially flat upper support surface 182 of the cutting apparatus 180 so as to be disposed under the first and second rollers 186 and 188. Preferably, the curled laminated optical effect material 20 is disposed on the substantially flat upper support surface 182 of the cutting apparatus 180 in such a way that the curled laminated optical effect material 20 curls toward the substantially flat upper support surface 182 of the cutting apparatus 180, thereby temporarily maintaining the curled laminated optical effect material 20 in a flattened state.

Although a first and a second roller 186 and 188 are shown, any technique may be utilized that temporarily flattens the curled laminated optical effect material 20 while it is being cut. As shown, the first and second rollers 186 and 188 are disposed above the substantially flat upper support surface 182 of the cutting apparatus 180 a distance approximating the thickness of the laminated optical effect material 20. This prevents the first and second rollers 186 and 188 from placing pressure sufficient to remove some of the curl from the laminated optical effect material 20.

The cutting element 190 is selectively moveable between a retracted position, as shown in FIG. 12, and an extended position, as shown in FIG. 13. In the retracted position (FIG. 12) the cutting element 190 is spatially separated from and disposed at a position above the bevel 184 of the cutting apparatus 180. When the cutting element 190 is in this position, the laminated optical effect material 20 is fed in the direction indicated by an arrow 192 toward the bevel 184 of the cutting apparatus 180. The first end 32 of the laminated optical effect material 20 serves as the leading edge of the laminated optical effect material 20 as it is fed through the cutting apparatus 180.

The first end 32 of the laminated optical effect material 20 is fed through the cutting apparatus 180 until the first end 32 extends over the bevel 184 of the cutting apparatus 180 a distance approximating the desired width of an individual segment of decorative grass 194. The cutting element 190 is then moved to the extended position (FIG. 13) wherein the cutting element 190 engages the bevel 184 of the cutting apparatus 180. This action results in contact of the cutting element 190 along the entire width 38 of the laminated optical effect material 20 which severs the individual segment of decorative grass 194 from the laminated optical effect material 20. The severed individual segment of decorative grass 194 does not remain attached to any unslit portion of the laminated optical effect material 20; therefore, the severed individual segment of decorative grass 194 is provided with a length which is equivalent to the width 38 of the laminated optical effect material 20. Preferably, each decorative grass segment 194 has a length ranging from about 2 inches to about 24 inches, and a width ranging from about 0.02 inches to about 0.125 inches. The cutting element 190 thereafter returns to the retracted position, and the process is repeated until the laminated optical effect material 20 has been cut to form several pieces of curled decorative grass 194 having an optical effect.

FIGS. 14 and 15 show one method for cutting a curled laminated optical effect material 20 to form curled optical effect glitter 195. Although only one method is shown, any known method by which a curled laminated optical effect material 20 may be cut to form curled optical effect glitter 195 may be utilized without departing from the spirit and scope of the present invention. It should also be noted that, although the method shown in FIGS. 14 and 15 depicts a curled laminated optical effect material 20 being cut to form curled optical effect glitter 195, the method may also be used to cut the crimped laminated optical effect material 178 (FIG. 11) to form crimped glitter having an optical effect. Furthermore, although the method shown and described herein contemplates cutting a curled laminated optical effect material 20 to form curled optical effect glitter 195, it should be noted that the curled glitter 195 having an optical effect may be formed by cutting a plurality of pieces of curled decorative grass 194 having an optical effect.

A cutting apparatus 180a is shown in FIGS. 14 and 15. The cutting apparatus 180a is similar to the cutting apparatus 180 of FIGS. 12 and 13 except that a cutting element 190a of the cutting apparatus 180a comprises a plurality of cross-cut elements, only one of which is designated 196, the cross-cut elements 196 extending substantially perpendicular from the cutting element 190a.

The same process as described and shown in FIGS. 12 and 13 is followed. However, when the cutting element 190a cuts the curled laminated optical effect material 20, the cutting element 190a and the cross-cut elements 196 cut the curled laminated optical effect material 20 into small pieces of curled glitter having an optical effect, only one of which is designated 198. Preferably, each piece of glitter has a surface diameter ranging from about 0.005 inches to about 0.5 inches.

As stated hereinbefore, this method may be utilized with the crimped laminated optical effect material 178 (FIG. 11) to form crimped glitter having an optical effect. In order for this process to be effective in forming crimped glitter, however, it is desirable that, when the crimps are set in the sheet of optical effect material, the spacing between crimps is such that a crimp will be formed in each piece of glitter 198. The spacing between crimps, therefore, will be dependent on the dimensions of the cutting element 190a in relation to the cross-cut elements 196.

Changes may be made in the construction and the operation of the various components, elements and assemblies described herein or in the steps or the sequence of steps of the methods described herein without departing from the spirit and scope of the invention as defined in the following claims.

What is claimed is:

1. A curled decorative grass having an optical effect, the curled decorative grass produced by a method comprising the steps of:
providing a sheet of laminated optical effect material having at least one curl set therein, the sheet of laminated optical effect material comprising:
a first sheet of substantially iridescent material;
a second sheet of material laminated to the first sheet of substantially iridescent material such that at least one surface of the sheet of laminated material maintains the iridescent properties of the first sheet of substantially iridescent material; and
wherein the at least one curl set in the sheet of laminated optical effect material is formed by providing the second sheet of material with a dimension that is less than the corresponding dimension of the first sheet of substantially iridescent material, and stretching the second sheet of material in said dimension and laminating the stretched second sheet of material to the first sheet of substantially iridescent material; and
cutting the sheet of laminated optical effect material having at least one curl set therein to form individual curled segments of decorative grass having an optical effect.

2. The curled decorative grass of claim 1 wherein, in the step of cutting the sheet of laminated optical effect material having at least one curl set therein to form individual curled segments of decorative grass, the curled segments of decorative grass have a length of from about 2 inches to about 24 inches and a width of from about 0.02 inches to about 0.125 inches.

3. The curled decorative grass of claim 1 wherein, in the step of providing the sheet of laminated optical effect material, the second sheet of material is laminated to the first sheet of substantially iridescent material with a tinted bonding material.

4. A decorative grass having an optical effect, the decorative grass formed by a method comprising the steps of:
providing a sheet of laminated optical effect material, the sheet of laminated optical effect material comprising:
a first sheet of substantially iridescent material;
a second sheet of material laminated to the first sheet of substantially iridescent material to provide the sheet of laminated optical effect material such that at least one surface of the sheet of laminated material maintains the iridescent properties of the first sheet of substantially iridescent material;
forming a distortion in the sheet of laminated optical effect material to provide a distorted sheet of laminated optical effect material, the distortion being selected from the group consisting of at least one curl, at least one crimp and combinations thereof, and wherein the distortion is formed in the sheet of laminated optical effect material by contacting at least one surface of the sheet of laminated optical effect material with a surface capable of providing a distortion in the sheet of laminated optical effect material and applying at least one of heat and pressure to form the distortion in the sheet of laminated optical effect material; and
cutting the distorted sheet of laminated optical effect material to form individual segments of decorative grass having an optical effect and the distortion set therein.

5. The decorative grass of claim 4 wherein, in the step of cutting the distorted sheet of laminated optical effect material to form individual segments of decorative grass, the segments of decorative grass have a length of from about 2 inches to about 24 inches and a width of from about 0.02 inches to about 0.125 inches.

6. The decorative grass of claim 4 wherein, in the step of forming a distortion in the sheet of laminated optical effect material, the distortion formed in the sheet of laminated material is at least one curl.

7. The decorative grass of claim 4 wherein, in the step of forming a distortion in the sheet of laminated optical effect material, the distortion formed in the sheet of laminated optical effect material is a plurality of crimps.

8. The decorative grass of claim 4 wherein, in the step of providing the sheet of laminated optical effect material, the first sheet of material is laminated to the second sheet of substantially iridescent material with a tinted bonding material.

9. A decorative grass having an optical effect, the decorative grass formed by a method comprising the steps of:
providing a sheet of laminated optical effect material having a preset distortion formed therein, the preset distortion selected from the group consisting of a curl, at least one crimp and combinations thereof, the sheet of laminated optical effect material comprising:
a first sheet of substantially iridescent material; and
a second sheet of material laminated to the first sheet of substantially iridescent material to provide the sheet of laminated material such that the sheet of laminated material maintains the iridescent properties of the first sheet of substantially iridescent material; and
cutting the sheet of laminated optical effect material having the preset distortion formed therein to form individual segments of decorative grass having an optical effect and the preset distortion therein.

10. The decorative grass of claim 9 wherein, in the step of cutting the sheet of laminated optical effect material to form individual segments of decorative grass, the individual segments of decorative grass have a length of from about 2 inches to about 24 inches and a width of from about 0.02 inches to about 0.125 inches.

11. The decorative grass of claim 9 wherein, in the step of providing the sheet of laminated optical effect material, the second sheet of material is laminated to the first sheet of substantially iridescent material with a tinted bonding material.

12. A crimped decorative grass having an optical effect, the crimped decorative grass produced by a method comprising the steps of:
providing a sheet of laminated optical effect material having a plurality of crimps set therein, the sheet of laminated optical effect material comprising:
a first sheet of substantially iridescent material; and
a second sheet of material laminated to the first sheet of substantially iridescent material to provide the sheet of laminated optical effect material such that at least one surface of the sheet of laminated optical effect material maintains the iridescent properties of the first sheet of substantially iridescent material; and
cutting the sheet of laminated optical effect material having a plurality of crimps set therein to form individual segments of decorative grass having an optical effect and at least one crimp set therein.

13. The crimped decorative grass of claim 12 wherein, in the step of cutting the sheet of laminated optical effect material having a plurality of crimps set therein to form individual segments of decorative grass having an optical effect and at least one crimp set therein, the individual segments of decorative grass have a length of from about 2 inches to about 24 inches and a width of from about 0.02 inches to about 0.125 inches.

14. The crimped decorative grass of claim 12 wherein, in the step of providing the sheet of laminated optical effect material, the second sheet of material is laminated to the first sheet of substantially iridescent material with a tinted bonding material.

15. A curled decorative grass having an optical effect, the curled decorative grass produced by a method comprising the steps of:
providing a sheet of laminated optical effect material having at least one curl set therein, the sheet of laminated optical effect material comprising:
a first sheet of substantially iridescent material;
a second sheet of material laminated to the first sheet of substantially iridescent material such that at least one surface of the sheet of laminated material maintains the iridescent properties of the first sheet of substantially iridescent material; and
wherein the at least one curl is formed in the sheet of laminated optical effect material by contacting at least one surface of the sheet of laminated optical effect material with a surface capable of providing at least one curl in the sheet of laminated optical effect material and applying at least one of heat and pressure to form the at least one in the sheet of laminated optical effect material; and
cutting the sheet of laminated optical effect material having at least one curl set therein to form individual curled segments of decorative grass having an optical effect.

16. The curled decorative grass of claim 15 wherein, in the step of cutting the sheet of laminated optical effect material having at least one curl set therein to form individual curled segments of decorative grass, the curled segments of decorative grass have a length of from about 2 inches to about 24 inches and a width of from about 0.02 inches to about 0.125 inches.

17. The curled decorative grass of claim 15 wherein, in the step of providing the sheet of laminated optical effect material, the second sheet of material is laminated to the first sheet of substantially iridescent material with a tinted bonding material.
